(19) United States
(12) Patent Application Publication
(10) Pub. No.: US 2021/0195934 A1
(43) Pub. Date: Jul. 1, 2021

(54) MULTILAYER EDIBLE PRODUCTS COMPRISING A BARRIER LAYER

(71) Applicant: KRAFT FOODS GROUP BRANDS LLC, Chicago, IL (US)

(72) Inventor: Allison Therese Nowak, Elk Grove Village, IL (US)

(21) Appl. No.: 16/729,761

(22) Filed: Dec. 30, 2019

(51) Int. Cl. A23P 20/10; A23P 20/20; A23D 9/013; A23G 3/34; A23G 3/54

(52) U.S. Cl. CPC A23P 20/11; A23P 20/20; A23G 3/54; A23G 3/346; A23D 9/013

(57) ABSTRACT

A multilayer edible product includes a first layer, a second layer having a water activity that may be less than the water activity of the layer, and an edible moisture barrier layer positioned between the first layer and the second layer. The edible moisture barrier layer may include high-melting fat and may mitigate moisture migration from the first layer to the second layer.

### BACKGROUND

### Field

The present specification generally relates to multilayer edible products having a first layer, a second layer, and a barrier layer positioned between the first layer and the second layer. In particular, the present specification relates to edible moisture barrier layer that includes high-melting fat and mitigates moisture migration from the first layer to the second layer.

### Technical Background

Moisture migration from one layer of an edible food product to another layer of the edible food product due to water activity gradients is a problem in typical multilayer food products. This moisture migration may result in unstable products with short shelf lives and may cause microbial or product quality issues.

Accordingly, a need exists for multilayer edible products that prevent migration of moisture from layer to layer of the multilayer edible products, and particularly prevents the migration of moisture from a layer having a higher water activity to a layer having a lower water activity.

### SUMMARY

According to one embodiment, a multilayer edible product comprises a first layer having a water activity greater than 0.75; a second layer having a water activity from 0.20 to 0.40; and an edible moisture barrier layer positioned between the first layer and the second layer. The edible moisture barrier layer comprises high-melting fat and mitigates moisture migration from the first layer to the second layer.

In another embodiment, a multilayer edible product comprises a first layer comprising one or more gelled substances, a flavoring component, and thickening agent; a second layer comprising a second layer comprising hydrophilic granulated particulates, a compound coating, and a fat source; and an edible moisture barrier layer positioned between the first layer and the second layer. The edible moisture barrier layer comprises high-melting fat and may be configured to prevent moisture migration from the first layer to the second layer.

Additional features and advantages of the multilayer edible products described herein and methods for making the same will be set forth in the detailed description which follows, and will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWING

FIG. 1 is a schematic depiction of a cross section of a multilayer edible product according to embodiments disclosed and described herein; and

FIG. 2 is a graphical depiction of the crust moisture content of various multilayer edible products according to embodiments disclosed and described herein.

### DETAILED DESCRIPTION

Reference will now be made in detail to various embodiments of multilayer edible products comprising a first layer, a second layer, and an edible moisture barrier layer. According to embodiments, a multilayer edible product comprises a first layer having a water activity from 0.20 to 0.40; a second layer having a water activity greater than 0.75; and an edible moisture barrier layer positioned between the first layer and the second layer. The edible moisture barrier layer comprises high-melting fat and mitigates moisture migration from the first layer to the second layer. Various embodiments of multilayer edible products comprising a first layer, a second layer, and a barrier layer will now be described with reference to the appended drawings.

Unless otherwise specified, a range of values, when recited, includes both the upper and lower limits of the range as well as any ranges there between. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the term “about” means both the precise number it precedes as well as variants of that precise number that would be envisioned by a person of ordinary skill in the art to provide similar effects as the precise number. For example, a range from “about 10 to about 20” includes a range from 10 to 20, and also includes variants below 10 that would be envisioned by a person of ordinary skill in the art to provide similar effects as 10 and includes variants above 20 that would be envisioned by a person of ordinary skill in the art to provide similar effects as 20.

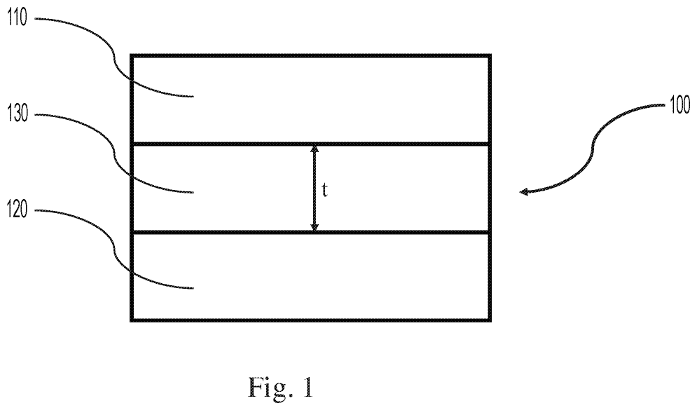

With reference now to FIG. 1, a cross section of a multilayer edible product 100 comprises a first layer 110, a second layer 120, and an edible moisture barrier layer 130. Although the embodiment of the multilayer edible product 100 depicted in FIG. 1 is rectangular in shape, it should be understood that in embodiments, the multilayer edible product 100 may have any suitable geometrical shape. As shown in FIG. 1, according to embodiments, an edible moisture barrier layer 130 may be located between at least two other layers of the multilayer edible product 100. Positioned on, and in physical contact with, the edible moisture barrier layer 130 are the first layer 110 and the second layer 120. As mentioned hereinabove, without the inclusion of an edible moisture barrier layer, moisture has a tendency to migrate from the first layer 110 to the second layer 120 of the multilayer edible product 100 when the first layer 110 has a higher water activity than the second layer 120. The edible moisture barrier layer 130, in embodiments, may be positioned between, and in physical contact with, both the first layer 110 and the second layer 120 to prevent this migration of moisture from the first layer 110 to the second layer 120.

The First Layer

As described above, the first layer 110 of the multilayer edible product 100 may be, according to embodiments, generally separated from the second layer 120 by the edible moisture barrier layer 130. According to embodiments, the composition of the first layer 110 of the multilayer edible product 100 has a water activity that may be greater than the water activity of the second layer 120. As described above, when there is a water activity differential between the first layer 110 and the second layer 120 (such as when the water activity of the first layer 110 is greater than the water activity of the second layer 120), moisture may migrate from the first layer 110 to the second layer 120. It should be understood that the greater the difference between the water activity of the first layer 110 and the second layer 120, the more pronounced the migration of moisture will be.

Although the composition of the first layer 110 may be not be particularly limited, the first layer 110 will typically have a water activity that may be greater than the water activity of the second layer 120. In embodiments, the first layer 110 may comprise one or more gelled substances, a flavoring component, a thickening agent, or combinations thereof. When the first layer 110 comprises a gelled substance, it will typically have a water activity that is greater than the water activity of the second layer 120. Accordingly, in embodiments, the first layer 110 comprises one or more gelled substances. As used herein, the term “gelled substances” means any water-based substance that may be thickened through the use of additional solids, such as nonfat dry milk, starch, gelatin, gums, or other similar agents. The first layer 110 may also be thickened through the culturing mechanisms, such as with cream cheese or other soft cheeses. In certain embodiments, the first layer 110 may include milk derived from cheese, and may optionally include meat or vegetable broths, egg, syrups, or the like. As such, the term “gelled substances” may, according to some embodiments, refer to mascarpone, cream cheese, heavy cream, soft cheese, skim milk, 1% milk, 2% milk, whole milk, whipping cream, heavy cream, custards, fruit curds, savory pies (meat and/or vegetable), sweet pies (fruit and/or vegetable based), or combinations thereof.

According to embodiments, the first layer 110 may comprise greater than or equal to about 30.0 wt % of the one or more gelled substances, such as greater than or equal to about 35.0 wt % of the one or more gelled substances, greater than or equal to about 40.0 wt % of the one or more gelled substances, greater than or equal to about 45.0 wt % of the one or more gelled substances, greater than or equal to about 50.0 wt % of the one or more gelled substances, greater than or equal to about 55.0 wt % of the one or more gelled substances, or greater than or equal to about 60.0 wt % of the one or more gelled substances.

For each of the above ranges, the maximum content of one or more gelled substances present in the first layer 110 may be, according to embodiments, about 90.0 wt %. Accordingly, in embodiments, the content of the one or more gelled substances in the first layer 110 may be from greater than or equal to about 25.0 wt % to less than or equal to about 90.0 wt %, such as from greater than or equal to about 30.0 wt % to less than or equal to about 90.0 wt %, from greater than or equal to about 35.0 wt % to less than or equal to about 90.0 wt %, from greater than or equal to about 40.0 wt % to less than or equal to about 90.0 wt %, from greater than or equal to about 45.0 wt % to less than or equal to about 90.0 wt %, from greater than or equal to about 50.0 wt % to less than or equal to about 90.0 wt %, from greater than or equal to about 55.0 wt % to less than or equal to about 90.0 wt %, or from greater than or equal to about 60.0 wt % to less than or equal to about 90.0 wt %. In embodiments, the content of one or more gelled substances present in the first layer 110 may be from greater than or equal to about 50.0 wt % to less than or equal to about 70.0 wt %, such as from greater than or equal to about 52.0 wt % to less than or equal to about 68.0 wt %, from greater than or equal to about 54.0 wt % to less than or equal to about 66.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

In embodiments where the first layer 110 comprises one or more gelled substances, the first layer 110 may further comprise other components, such as a flavoring component, a thickening agent, a preservative, or combinations thereof. As used herein, the term “flavoring component” may be used broadly to refer to any natural or artificial edible agents that provides the first layer 110 with additional flavors. The natural or artificial edible agents may be either dry or liquid. Examples of suitable flavoring components may include, but are not limited to, chocolate, white chocolate, cocoa, jelly, jam, curd, peanuts, tree nuts, coconut paste, butter, caramel, curd, salt, sugar, brown sugar, fruit powders, fruit purees, or combinations thereof. According to embodiments, the first layer 110 may comprise from about 25 wt % to about 90 wt % of the one or more gelled substances, from about 10 wt % to about 30 wt % of the flavoring component, and from about 0.1 wt % to about 5 wt % of the thickening agent. Each of the flavoring component, the thickening agent, and the preservative will be described in more detail below.

As disclosed above, the first layer 110 may comprise a flavoring component in either dry or liquid form. The flavoring component may be, according to embodiments, any natural or artificial flavoring agent, such as chocolate, white chocolate, cocoa, jelly, jam, curd, peanuts, tree nuts, coconut paste, butter, caramel, curd, salt, sugar, brown sugar, fruit powders, fruit purees, syrups, or combinations thereof. In embodiments that include the additional solids, sugar, salt, or combinations thereof, these components may absorb some of the moisture in the first layer 110, which can mitigate some of the migration of moisture from the first layer 110 to the second layer 120. In addition, the additional solids, sugar, salt, or combinations thereof may improve the homogeneity of the first layer 110 composition and provide improved mouthfeel. However, if too much sugar/and or salt is added to the first layer 110, the sugar/and or salt may reduce the moisture of the first layer 110 to a level that may be undesirable, and which may prevent the first layer 110 from achieving a desirable consistency, mouthfeel, water activity, etc.

Accordingly, in embodiments, the content of flavoring component in the first layer 110 may be greater than or equal to about 0.5%, such as greater than or equal to about 1.0 wt %, greater than or equal to about 2.5 wt %, greater than or equal to about 5.0 wt %, greater than or equal to about 7.5 wt %, greater than or equal to about 10.0 wt %, greater than or equal to about 12.5 wt %, greater than or equal to about 15.0 wt %, greater than or equal to about 17.5 wt %, greater than or equal to about 20.0 wt %, greater than or equal to about 22.5 wt %, greater than or equal to about 25.0 wt %, greater than or equal to about 27.5 wt %, greater than or equal to about 30.0 wt %, greater than or equal to about 32.5 wt %, or greater than or equal to about 35.0 wt %. In some embodiments, the maximum content of the flavoring component in the first layer 110 may be about 40.0 wt %. Accordingly, in some embodiments, the content of flavoring component in the first layer 110 may be from greater than or equal to about 0.5 wt % to less than or equal to about 40.0 wt %, such as from greater than or equal to about 1.0 wt % to less than or equal to about 40.0 wt %, greater than or equal to about 2.5 wt % to less than or equal to about 40.0 wt %, greater than or equal to about 5.0 wt % to less than or equal to about 40.0 wt %, greater than or equal to about 7.5 wt % to less than or equal to about 40.0 wt %, greater than or equal to about 10.0 wt % to less than or equal to about 40.0 wt %, greater than or equal to about 12.5 wt % to less than or equal to about 40.0 wt %, from greater than or equal to about 15.0 wt % to less than or equal to about 40.0 wt %, from greater than or equal to about 17.5 wt % to less than or equal to about 40.0 wt %, from greater than or equal to about 20.0 wt % to less than or equal to about 40.0 wt %, from greater than or equal to about 22.5 wt % to less than or equal to about 40.0 wt %, from greater than or equal to about 25.0 wt % to less than or equal to about 40.0 wt %, from greater than or equal to about 27.5 wt % to less than or equal to about 40.0 wt %, from greater than or equal to about 30.0 wt % to less than or equal to about 40.0 wt %, from greater than or equal to about 32.5 wt % to less than or equal to about 40.0 wt %, or from greater than or equal to about 35.0 wt % to less than or equal to about 40.0 wt %. In some embodiments, the content of the flavoring component in the first layer 110 may be from greater than or equal to about 0.5 wt % to less than or equal to about 25.0 wt %, such as from greater than or equal to about 1.0 wt % to less than or equal to about 25.0 wt %, greater than or equal to about 2.5 wt % to less than or equal to about 25.0 wt %, greater than or equal to about 5.0 wt % to less than or equal to about 25.0 wt %, greater than or equal to about 7.5 wt % to less than or equal to about 25.0 wt %, greater than or equal to about 10.0 wt % to less than or equal to about 25.0 wt %, greater than or equal to about 12.0 wt % to less than or equal to about 25.0 wt %, from greater than or equal to about 14.0 wt % to less than or equal to about 25.0 wt %, from greater than or equal to about 15.0 wt % to less than or equal to about 25.0 wt %, from greater than or equal to about 16.0 wt % to less than or equal to about 24.0 wt %, from greater than or equal to about 17.0 wt % to less than or equal to about 23.0 wt %, from greater than or equal to about 18.0 wt % to less than or equal to about 22.0 wt %, or from greater than or equal to about 19.0 wt % to less than or equal to about 21.0 wt %.

According to embodiments, the first layer 110 may further comprise a thickening agent. In embodiments, the thickening agent may be selected from wheat flour, cornstarch, potato starch, tapioca, arrowroot, pre-gelatinized starch, agar-agar, algin, carrageenan, gelatin, gum Arabic, gum tragacanth, pectin, katakuri starch, sago, almond flour, guar gum, locust bean gum, xanthan gum, dextrin, cyclodextrin, maltodextrin, rice flour, food starch, modified food starch, modified corn starch, wheat starch, oat fiber, citrus fiber, or combinations thereof. As will be discussed in more detail below, controlling the melting point and viscosity of the first layer 110 allows for a multilayer edible product 100 with a first layer 110 that may be homogenous, which results in a desirable mouth feel. The thickening agent may be added in amounts that help to control the viscosity of the first layer 110 at varying temperatures. According to embodiments, the content of the thickening agent in the first layer 110 may be greater than or equal to about 0.01 wt %, such as greater than or equal to about 0.1 wt %, greater than or equal to about 0.5 wt %, greater than or equal to about 1.0 wt %, or greater than or equal to about 2.5 wt %. In some embodiments, the maximum content of the thickening agent in the first layer 110 may be about 10.0 wt %. Accordingly, in embodiments, the content of the thickening agent in the first layer 110 may be from greater than or equal to about 0.01 wt % to less than or equal to about 10.0 wt %, such as from greater than or equal to about 0.1 wt % to less than or equal to about 10.0 wt %, from greater than or equal to about 0.5 wt % to less than or equal to about 10.0 wt %, from greater than or equal to about 1.0 wt % to less than or equal to about 10.0 wt %, or from greater than or equal to about 2.5 wt % to less than or equal to about 10.0 wt %. In some embodiments, the content of the thickening agent in the first layer 110 may be from greater than or equal to about 1.0 wt % to less than or equal to about 9.0 wt %, from greater than or equal to about 1.0 wt % to less than or equal to about 8.0 wt %, from greater than or equal to about 1.0 wt % to less than or equal to about 7.0 wt %, from greater than or equal to about 1.0 wt % to less than or equal to about 6.0 wt %, or from greater than or equal to about 1.0 wt % to less than or equal to about 5.0 wt %.

A preservative may optionally be added to embodiments of the first layer 110 to preserve the first layer 110 from decay or spoliation. In embodiments, the preservative may include natural preservatives, artificial preservatives, or combinations thereof. In one or more embodiments the preservative may be selected from sorbic acid, citric acid, acetic acid, fumaric acid, lactic acid, phosphoric acid, malic acid, tartaric acid, sodium sorbate, benzoic acid, benzoates, parabens, sulfur dioxide, sulfites, nitrites, nitrates, propionic acid, propionates, cultured milk, cultured dextrose, cultured vinegar, potassium sorbate, cultured dairy, natamycin, nisin, or combinations thereof. As stated above, the preservative may be an optional component of the first layer 110, thus in embodiments disclosed and described herein, the first layer 110 does not include any preservatives. Accordingly, in embodiments, the content of the preservative in the first layer 110 may be greater than or equal to about 0.0 wt %, such as greater than or equal to about 0.0001 wt %, greater than or equal to about 0.001 wt %, greater than or equal to about 0.01 wt %, greater than or equal to about 0.1 wt %, or greater than or equal to about 1.0 wt %. In some embodiments, the maximum content of the thickening agent in the first layer 110 may be about 4.0 wt %. Accordingly, in embodiments, the content of the thickening agent in the first layer 110 may be from greater than or equal to about 0.0 wt % to less than or equal to about 4.0 wt %, such as from greater than or equal to about 0.0001 wt % to less than or equal to about 4.0 wt %, from greater than or equal to about 0.001 wt % to less than or equal to about 4.0 wt %, from greater than or equal to about 0.01 wt % to less than or equal to about 4.0 wt %, from greater than or equal to about 0.1 wt % to less than or equal to about 4.0 wt %, from greater than or equal to about 1.0 wt % to less than or equal to about 4.0 wt %, from greater than or equal to about 2.0 wt % to less than or equal to about 4.0 wt %, or from greater than or equal to about 3.0 wt % to less than or equal to about 4.0 wt %. In embodiments, the content of the thickening agent in the first layer 110 may be from greater than or equal to about 0.0 wt % to less than or equal to about 1.0 wt %, such as from greater than or equal to about 0.0001 wt % to less than or equal to about 1.0 wt %, from greater than or equal to about 0.001 wt % to less than or equal to about 1.0 wt %, from greater than or equal to about 0.01 wt % to less than or equal to about 1.0 wt %, from greater than or equal to about 0.1 wt % to less than or equal to about 1.0 wt %, or from greater than or equal to about 0.5 wt % to less than or equal to about 1.0 wt %.

The one or more gelled substances, flavoring component, thickening agent, and, optionally, preservative may be mixed together to form the first layer 110 by any suitable method. According to embodiments, the one or more gelled substances, flavoring component, thickening agent, and, optionally, preservative are combined into a vessel and mixed at temperatures sufficient to allow for homogenous mixing of the one or more gelled substances, flavoring component, thickening agent, and, optionally, preservative. The mixing may be accomplished by conventional techniques and with conventional equipment known in the art. Once the one or more gelled substances, flavoring component, thickening agent, and, optionally, preservative are combined into a homogenous mixture, the mixture may be cooled to room temperature and may be formed into the first layer 110 by any suitable method and/or mechanism known in the art.

The content of one or more gelled substances, flavoring component, thickening agent, and, optionally, preservative in the first layer 110 may be balanced to control the water activity of the first layer 110 at varying temperatures. In addition to controlling the water activity of the first layer 110, the content of one or more gelled substances, flavoring component, thickening agent, and, optionally, preservative in the first layer 110 may be balanced to control the viscosity, melting temperature, and/or relaxation time of the first layer 110. By controlling the water activity, viscosity, melting temperature, and/or relaxation time of the first layer 110, a first layer may be formulated so that the first layer 110 has a suitable mouth feel.

According to embodiments, the contents of the first layer 110 may be balanced so that the first layer 110 has a water activity of greater than about 0.75, such as a water activity of greater than about 0.76, a water activity of greater than about 0.77, a water activity of greater than about 0.78, a water activity of greater than about 0.79, a water activity of greater than about 0.80, a water activity of greater than about 0.81, a water activity of greater than about 0.82, a water activity of greater than about 0.83, a water activity of greater than about 0.84, a water activity of greater than about 0.85, a water activity of greater than about 0.86, a water activity of greater than about 0.87, a water activity of greater than about 0.88, a water activity of greater than about 0.89, a water activity of greater than about 0.90, a water activity of greater than about 0.91, a water activity of greater than about 0.92, a water activity of greater than about 0.93, a water activity of greater than about 0.94, or a water activity of greater than about 0.95. In some embodiments, the maximum water activity of the first layer 110 may be about 0.95. Accordingly, in some embodiments, the contents of the first layer 110 may be balanced so that the water activity of the first layer 110 may be from greater than or equal to about 0.75 to less than or equal to about 0.95, such as a water activity of greater than or equal to about 0.76 to less than or equal to about 0.95, a water activity of greater than or equal to about 0.77 to less than or equal to about 0.95, a water activity of greater than or equal to about 0.78 to less than or equal to about 0.95, a water activity of greater than or equal to about 0.79 to less than or equal to about 0.95, a water activity of greater than or equal to about 0.80 to less than or equal to about 0.95, a water activity of greater than or equal to about 0.81 to less than or equal to about 0.95, a water activity of greater than or equal to about 0.82 to less than or equal to about 0.95, a water activity of greater than or equal to about 0.83 to less than or equal to about 0.95, a water activity of greater than or equal to about 0.84 to less than or equal to about 0.95, a water activity of greater than or equal to about 0.85 to less than or equal to about 0.95. In some embodiments, the water activity of the first layer 110 may be from greater than or equal to about 0.75 to less than or equal to about 0.92, from greater than or equal to about 0.76 to less than or equal to about 0.89, from greater than or equal to about 0.77 to less than or equal to about 0.86, from greater than or equal to 0.78 to less than or equal to about 0.83, from greater than or equal to about 0.78 to less than or equal to about 0.82, or from greater than or equal to about 0.79 to less than or equal to about 0.81.

The Second Layer

As described above, the second layer 120 of the multilayer edible product 100 may be generally separated, according to embodiments, from the first layer 110 by the edible moisture barrier layer 130. According to embodiments, the composition of the second layer 120 of the multilayer edible product 100 has a water activity that may be less than the water activity of the first layer 110. As described above, when there is a water activity differential between the first layer 110 and the second layer 120 (such as when the water activity of the first layer 110 is greater than the water activity of the second layer 120), moisture may migrate from the first layer 110 to the second layer 120. It should be understood that the greater the difference between the water activity of the first layer 110 and the second layer 120, the more pronounced the migration of moisture will be.

Although the composition of the second layer 120 may be not be particularly limited, the second layer 110 will typically have a water activity that may be less than the water activity of the first layer 110. In embodiments, the second layer 120 may comprise hydrophilic granulated particulates, a compound coating, and a fat source. When the second layer 120 comprises hydrophilic granulated particulates, it will typically have a water activity that may be less than the water activity of the first layer 110. Accordingly, in embodiments, the second layer 120 comprises hydrophilic granulated particulates. As used herein, the term “hydrophilic granulated particulates” means powders, grains, or crumbs having diameters of less than 100 μm and attract and absorb water. As such, the term “hydrophilic granulated particulates” may refer to any suitable edible fragment of baked goods, such as breadcrumbs, cake crumbs, cookie crumbs, crackers, or combinations thereof.

In embodiments where the second layer 120 comprises hydrophilic granulated particulates, the hydrophilic granulated particulates are pulverized into a desired particle size. As should be understood, the particle size of the hydrophilic granulated particulates will affect the consistency and overall mouth feel of the second layer 120 of the multilayer edible product 100. For instance, if the particle size of the hydrophilic granulated particulates is too large, the second layer 120 will be gritty, have an unpleasant mouth feel, and will not melt homogeneously. In embodiments, the hydrophilic granulated particulates may be pulverized by any conventional mechanism, such as grinding, milling, pressing, jet milling, food processing, mortar and pestle, and the like. According to embodiments, the hydrophilic granulated particulates may be pulverized such that a medium particle size distribution, D₅₀, as measured by laser diffraction, of the hydrophilic granulated particles may be less than or equal to about 20.0 μm, such as less than or equal to about 18.0 μm, less than or equal to about 15.0 μm, less than or equal to about 12.0 μm, less than or equal to about 10.0 μm, less than or equal to about 8.0 μm, or less than or equal to about 5.0 μm. Thus, according to embodiments, the hydrophilic granulated particulates may be pulverized such that a medium particle size distribution, D₅₀, may be from greater than or equal to about 2.0 μm to less than or equal to about 20.0 μm, such as from greater than or equal to about 5.0 μm to less than or equal to about 18.0 μm, from greater than or equal to about 10.0 μm to less than or equal to about 16.0 μm, or from greater than or equal to about 12.0 μm to less than or equal to about 14.0 μm, or about about 15.0 μm.

According to one or more embodiments, the hydrophilic granulated particulates may be pulverized such that a particle size distribution, D₉₀, as measured by laser diffraction, of the hydrophilic granulated particles may be less than or equal to about 45.0 μm, such as less than or equal to about 42.0 μm, less than or equal to about 40.0 μm, less than or equal to about 38.0 μm, or less than or equal to about 35.0 μm. Thus, according to embodiments, the hydrophilic granulated particulates may be pulverized such that a particle size distribution, D₉₀, may be from greater than or equal to about 30.0 μm to less than or equal to about 45.0 μm, such as from greater than or equal to about 35.0 μm to less than or equal to about 42.0 μm, or from greater than or equal to about 38.0 μm to less than or equal to about 40.0 μm.

Alternatively, the particle size of the hydrophilic granulated particulates may be determined by screening methods. In embodiments, the hydrophilic granulated particulates may include a first portion of sized particles. The first portion of sized particles may include the following attributes when screened according to traditional methods: U.S. Screen #20, in which 20% to 30% of the sized particles are retained; U.S. Screen #40, in which 30% to 50% of the sized particles are retained; and U.S. Screen #80, in which 30% to 50% of the sized particles are retained. A maximum of 5% of the sized particles present in the first portion may be retained after sieving. In one or more embodiments, the hydrophilic granulated particulates may include a second portion of sized particles. The second portion of sized particles may include the following attributes when screened according to traditional methods: U.S. Screen #5, in which 0% to 10% of the sized particles are retained; U.S. Screen #10, in which 15% to 30% of the sized particles are retained; and U.S. Screen #20, in which 20% to 40% of the sized particles are retained. A maximum of 50% of the sized particles present in the second portion may be retained after sieving.

It is believed that a smaller diameter of the hydrophilic granulated particulates present in the second layer 120 may correlate with increased shelf life of the multilayer edible product 100. Without being bound by theory, this relationship may arise because hydrophilic granulated particulates with smaller diameters have smaller surface areas, and are thus less likely to be exposed to moisture that may be present in the second layer 120. In other words, the hydrophilic granulated particulates with smaller diameters may be more closely and densely compacted together with each other. Therefore, the dense compacting of the hydrophilic granulated particulates may allow less moisture to travel throughout the second layer 120, and thus less likely that the moisture may be able to encounter a surface area of a hydrophilic granulated particulate that not fully covered in the fat source, which will be described in greater detail below.

According to embodiments, the second layer 120 may comprise from about 50 wt % to about 70 wt % of the hydrophilic granulated particulates, from about 10 wt % to about 30 wt % of the compound coating, and from about 10 wt % to about 30 wt % of the fat source. Each of the flavoring component, thickening agent, and the preservative will be described in more detail below.

According to embodiments, the second layer 120 may comprise greater than or equal to about 50.0 wt % of the hydrophilic granulated particulates, such as greater than or equal to about 52.5 wt % of the hydrophilic granulated particulates, greater than or equal to about 55.0 wt % of the hydrophilic granulated particulates, greater than or equal to about 57.5 wt % of the hydrophilic granulated particulates, greater than or equal to about 60.0 wt % of the hydrophilic granulated particulates, greater than or equal to about 62.5 wt % of the hydrophilic granulated particulates, greater than or equal to about 65.0 wt % of the hydrophilic granulated particulates, or greater than or equal to about 67.5 wt % of the hydrophilic granulated particulates.

For each of the above ranges, the maximum content of the hydrophilic granulated particulates present in the second layer 120 may be, according to embodiments, about 70.0 wt %. Accordingly, in embodiments, the content of the hydrophilic granulated particulates in the second layer 120 may be from greater than or equal to about 50.0 wt % to less than or equal to about 70.0 wt %, such as from greater than or equal to about 52.5 wt % to less than or equal to about 70.0 wt %, from greater than or equal to about 55.0 wt % to less than or equal to about 70.0 wt %, from greater than or equal to about 57.5 wt % to less than or equal to about 70.0 wt %, from greater than or equal to about 60.0 wt % to less than or equal to about 70.0 wt %, from greater than or equal to about 62.5 wt % to less than or equal to about 70.0 wt %, from greater than or equal to about 65.0 wt % to less than or equal to about 70.0 wt %, or from greater than or equal to about 67.5 wt % to less than or equal to about 70.0 wt %. In embodiments, the content of the hydrophilic granulated particulates present in the second layer 120 may be from greater than or equal to about 52.0 wt % to less than or equal to about 68.0 wt %, such as from greater than or equal to about 54.0 wt % to less than or equal to about 66.0 wt %, from greater than or equal to about 55.0 wt % to less than or equal to about 65.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

As disclosed above, the second layer 120 may comprise a compound coating. As used herein, the term “compound coating” may be used broadly to refer to any suitable agent that provides the second layer 120 with an additional flavoring component. As such, the term “compound coating” may refer to any suitable substance that includes edible oil and hydrophilic powder. In embodiments, the compound coating may further comprise whey, lecithin, salt, or combinations thereof.

The edible oil present in the compound coating of the second layer 120 may include any suitable animal fat, vegetable fat, or derivations thereof that are in a substantially solid state at temperatures exceeding 40° F. In one or more embodiments, the edible oil may have a saturated fat content of greater than 50 wt %, based on the total weight of the edible oil. In embodiments, the edible oil present in the compound coating of the second layer 120 may comprise coconut oil, palm kernel oil, cocoa butter, palm oil, hydrogenated cottonseed oil, or combinations thereof. The edible oil may be present in the compound coating at any level that provides a suitable mouthfeel. In embodiments, therefore, the compound coating may comprise from greater than or equal to about 50.0 wt % of the edible oil, such as greater than or equal to about 52.5 wt % of the edible oil, greater than or equal to 55.0 wt % of the edible oil, greater than or equal to about 57.5 wt % of the edible oil, greater than or equal to about 60.0 wt % of the edible oil, greater than or equal to about 62.5 wt % of the edible oil, greater than or equal to about 65.0 wt % of the edible oil, or greater than or equal to about 67.5 wt % of the edible oil.

For each of the above ranges, the maximum content the edible oil present in the compound coating may be, according to embodiments, about 70.0 wt %. Accordingly, in embodiments, the content of the edible oil in the compound coating may be from greater than or equal to about 50.0 wt % to less than or equal to about 70.0 wt %, such as from greater than or equal to about 52.5 wt % to less than or equal to about 70.0 wt %, from greater than or equal to about 55.0 wt % to less than or equal to about 70.0 wt %, from greater than or equal to about 57.5 wt % to less than or equal to about 70.0 wt %, from greater than or equal to about 60.0 wt % to less than or equal to about 70.0 wt %, from greater than or equal to about 62.5 wt % to less than or equal to about 70.0 wt %, from greater than or equal to about 65.0 wt % to less than or equal to about 70.0 wt %, or from greater than or equal to about 67.5 wt % to less than or equal to about 70.0 wt %. In embodiments, the content of the edible oil present in the compound coating may be from greater than or equal to about 52.0 wt % to less than or equal to about 68.0 wt %, such as from greater than or equal to about 54.0 wt % to less than or equal to about 66.0 wt %, from greater than or equal to about 55.0 wt % to less than or equal to about 65.0 wt %, from greater than or equal to about 56.0 wt % to less than or equal to about 64.0 wt %, from greater than or equal to about 58.0 wt % to less than or equal to about 62.0 wt %, or from greater than or equal to about 59.0 wt % to less than or equal to about 61.0 wt %.

Likewise, the hydrophilic powder present in the compound coating of the second layer 120 may include any suitable sugar, or derivations or extracts thereof. In embodiments, the hydrophilic powder may comprise brown sugar, granulated sugar, invert sugar, milled sugar, or combinations thereof. The hydrophilic powder may be present in the compound coating at any level that provides a suitable mouthfeel and sweetness. In embodiments, therefore, the compound coating may comprise from greater than or equal to about 20.0 wt % of the hydrophilic powder, such as greater than or equal to about 21.0 wt % of the hydrophilic powder, greater than or equal to about 22.0 wt % of the hydrophilic powder, greater than or equal to about 23.0 wt % of the hydrophilic powder, greater than or equal to about 24.0 wt % of the hydrophilic powder, greater than or equal to about 25.0 wt % of the hydrophilic powder, greater than or equal to about 26.0 wt % of the hydrophilic powder, greater than or equal to about 27.0 wt % of the hydrophilic powder, greater than or equal to about 28.0 wt % of the hydrophilic powder, or greater than or equal to about 29.0 wt % of the hydrophilic powder.

For each of the above ranges, the maximum content the hydrophilic powder present in the compound coating may be, according to embodiments, about 30.0 wt %. Accordingly, in embodiments, the content of the hydrophilic powder in the compound coating may be from greater than or equal to about 20.0 wt % to less than or equal to about 30.0 wt %, such as from greater than or equal to about 21.0 wt % to less than or equal to about 30.0 wt %, from greater than or equal to about 22.0 wt % to less than or equal to about 30.0 wt %, from greater than or equal to about 23.0 wt % to less than or equal to about 70.0 wt %, from greater than or equal to about 24.0 wt % to less than or equal to about 30.0 wt %, from greater than or equal to about 25.0 wt % to less than or equal to about 30.0 wt %, from greater than or equal to about 26.0 wt % to less than or equal to about 30.0 wt %, from greater than or equal to about 27.0 wt % to less than or equal to about 30.0 wt %, from greater than or equal to about 28.0 wt % to less than or equal to about 30.0 wt %, or from greater than or equal to about 29.0 wt % to less than or equal to about 30.0 wt %. In embodiments, the content of the edible oil present in the compound coating may be from greater than or equal to about 21.0 wt % to less than or equal to about 29.0 wt %, such as from greater than or equal to about 22.0 wt % to less than or equal to about 28.0 wt %, from greater than or equal to about 23.0 wt % to less than or equal to about 27.0 wt %, or from greater than or equal to about 24.0 wt % to less than or equal to about 26.0 wt %.

Optionally, the compound coating, may further include one or more additional components that may alter the compound coating's viscosity, mouthfeel, sweetness, flavor, water activity, etc. Suitable additional components may include, but are not limited to, a flavoring agent, a stabilizer, a bulking agent, a preservative, or combinations thereof. In some embodiments, the compound coating may comprise from greater than or equal to about 5.0 wt % of the one or more additional components, such as greater than or equal to about 6.0 wt % of the one or more additional components, greater than or equal to about 7.0 wt % of the one or more additional components, greater than or equal to about 8.0 wt % of the one or more additional components, greater than or equal to about 9.0 wt % of the one or more additional components, greater than or equal to about 10.0 wt % of the one or more additional components, greater than or equal to about 11.0 wt % of the one or more additional components, greater than or equal to about 12.0 wt % of the one or more additional components, greater than or equal to about 13.0 wt % of the one or more additional components, or greater than or equal to about 14.0 wt % of the one or more additional components.

For each of the above ranges, the maximum content the one or more additional components optionally present in the compound coating may be, according to embodiments, about 15.0 wt %. Accordingly, in embodiments, the content of the one or more additional components in the compound coating may be from greater than or equal to about 5.0 wt % to less than or equal to about 15.0 wt %, such as from greater than or equal to about 6.0 wt % to less than or equal to about 15.0 wt %, from greater than or equal to about 7.0 wt % to less than or equal to about 15.0 wt %, from greater than or equal to about 8.0 wt % to less than or equal to about 15.0 wt %, from greater than or equal to about 9.0 wt % to less than or equal to about 15.0 wt %, from greater than or equal to about 10.0 wt % to less than or equal to about 15.0 wt %, from greater than or equal to about 11.0 wt % to less than or equal to about 15.0 wt %, from greater than or equal to about 12.0 wt % to less than or equal to about 15.0 wt %, from greater than or equal to about 13.0 wt % to less than or equal to about 15.0 wt %, or from greater than or equal to about 14.0 wt % to less than or equal to about 15.0 wt %. In embodiments, the content of the one or more additional components present in the compound coating may be from greater than or equal to about 6.0 wt % to less than or equal to about 14.0 wt %, such as from greater than or equal to about 7.5 wt % to less than or equal to about 12.5 wt %, from greater than or equal to about 8.0 wt % to less than or equal to about 12.0 wt %, or from greater than or equal to about 9.0 wt % to less than or equal to about 11.0 wt %.

Regardless of the exact composition selected for the compound coating, the compound coating may be present in the second layer 120 at any suitable level. According to embodiments, the second layer 120 may comprise greater than or equal to about 10.0 wt % of the compound coating, such as greater than or equal to about 12.5 wt % of the compound coating, greater than or equal to about 15.0 wt % of the compound coating, greater than or equal to about 17.5 wt % of the compound coating, greater than or equal to about 20.0 wt % of the compound coating, greater than or equal to about 22.5 wt % of the compound coating, greater than or equal to about 25.0 wt % of the compound coating, or greater than or equal to about 27.5 wt % of the compound coating.

For each of the above ranges, the maximum content of the compound coating present in the second layer 120 may be, according to embodiments, about 30.0 wt %. Accordingly, in embodiments, the content of the compound coating in the second layer 120 may be from greater than or equal to about 10.0 wt % to less than or equal to about 30.0 wt %, such as from greater than or equal to about 12.5 wt % to less than or equal to about 30.0 wt %, from greater than or equal to about 15.0 wt % to less than or equal to about 30.0 wt %, from greater than or equal to about 17.5 wt % to less than or equal to about 30.0 wt %, from greater than or equal to about 20.0 wt % to less than or equal to about 30.0 wt %, from greater than or equal to about 22.5 wt % to less than or equal to about 30.0 wt %, from greater than or equal to about 25.0 wt % to less than or equal to about 30.0 wt %, or from greater than or equal to about 27.5 wt % to less than or equal to about 30.0 wt %. In embodiments, the content of the compound coating present in the second layer 120 may be from greater than or equal to about 12.0 wt % to less than or equal to about 28.0 wt %, such as from greater than or equal to about 14.0 wt % to less than or equal to about 26.0 wt %, from greater than or equal to about 15.0 wt % to less than or equal to about 25.0 wt %, from greater than or equal to about 16.0 wt % to less than or equal to about 24.0 wt %, from greater than or equal to about 18.0 wt % to less than or equal to about 22.0 wt %, or from greater than or equal to about 19.0 wt % to less than or equal to about 21.0 wt %.

As disclosed above, the second layer 120 further comprises a fat source. As used herein, the term “fat source” may be used broadly to refer to any suitable agent that provides the second layer 120 with an additional fat content. As such, the fat source may include palm kernel oil, coconut oil, cocoa butter, palm oil, anhydrous milk fat, non-anhydrous milk fat, butter, propylene glycol, glycerin, glycerol, or combinations thereof.

Accordingly, in embodiments, the content of the fat source in the second layer 120 may be greater than or equal to about 10.0%, such as greater than or equal to about 12.0 wt %, greater than or equal to about 14.0 wt %, greater than or equal to about 16.0 wt %, greater than or equal to about 18.0 wt %, greater than or equal to about 20.0 wt %, greater than or equal to about 22.0 wt %, greater than or equal to about 24.0 wt %, greater than or equal to about 25.0 wt %, greater than or equal to about 26.0 wt %, or greater than or equal to about 28.0 wt %. In some embodiments, the maximum content of the fat source in the second layer 120 may be about 30.0 wt %. Accordingly, in some embodiments, the content of fat source in the second layer 120 may be from greater than or equal to about 10.0 wt % to less than or equal to about 30.0 wt %, such as from greater than or equal to about 12.0 wt % to less than or equal to about 30.0 wt %, from greater than or equal to about 14.0 wt % to less than or equal to about 30.0 wt %, from greater than or equal to about 15.0 wt % to less than or equal to about 30.0 wt %, from greater than or equal to about 16.0 wt % to less than or equal to about 30.0 wt %, from greater than or equal to about 18.0 wt % to less than or equal to about 30.0 wt %, from greater than or equal to about 20.0 wt % to less than or equal to about 30.0 wt %, from greater than or equal to about 22.0 wt % to less than or equal to about 30.0 wt %, from greater than or equal to about 24.0 wt % to less than or equal to about 30.0 wt %, or from greater than or equal to about 25.0 wt % to less than or equal to about 30.0 wt %. In some embodiments, the content of the fat source in the second layer 120 may be from greater than or equal to about 10.0 wt % to less than or equal to about 25.0 wt %, such as from greater than or equal to about 12.0 wt % to less than or equal to about 25.0 wt %, from greater than or equal to about 14.0 wt % to less than or equal to about 25.0 wt %, from greater than or equal to about 15.0 wt % to less than or equal to about 25.0 wt %, from greater than or equal to about 16.0 wt % to less than or equal to about 24.0 wt %, from greater than or equal to about 17.0 wt % to less than or equal to about 23.0 wt %, from greater than or equal to about 18.0 wt % to less than or equal to about 22.0 wt %, or from greater than or equal to about 19.0 wt % to less than or equal to about 21.0 wt %.

Overall, regardless of the exact combination of the hydrophilic granulated particulates, a compound coating, and a fat source present in the second layer 120, the second layer may comprise any amount of solid particulates suitable to provide the second layer 120 with a desirable flavor, mouthfeel, viscosity, water activity, etc. Accordingly, in embodiments, the second layer 120 comprises from greater than or equal to about 70.0% of solid particulates, such as greater than or equal to about 71.0 wt %, greater than or equal to about 72.0 wt %, greater than or equal to about 73.0 wt %, greater than or equal to about 74.0 wt %, greater than or equal to about 75.0 wt %, greater than or equal to about 76.0 wt %, greater than or equal to about 77.0 wt %, greater than or equal to about 78.0 wt %, or greater than or equal to about 79.0 wt %.

In some embodiments, the maximum content of the solid particulates in the second layer 120 may be about 80.0 wt %. Accordingly, in some embodiments, the content of solid particulates in the second layer 120 may be from greater than or equal to about 70.0 wt % to less than or equal to about 80.0 wt %, such as from greater than or equal to about 71.0 wt % to less than or equal to about 80.0 wt %, from greater than or equal to about 72.0 wt % to less than or equal to about 80.0 wt %, from greater than or equal to about 73.0 wt % to less than or equal to about 80.0 wt %, from greater than or equal to about 74.0 wt % to less than or equal to about 80.0 wt %, from greater than or equal to about 75.0 wt % to less than or equal to about 80.0 wt %, from greater than or equal to about 76.0 wt % to less than or equal to about 80.0 wt %, from greater than or equal to about 77.0 wt % to less than or equal to about 80.0 wt %, from greater than or equal to about 78.0 wt % to less than or equal to about 80.0 wt %, or from greater than or equal to about 79.0 wt % to less than or equal to about 80.0 wt %. In some embodiments, the content of the fat source in the second layer 120 may be from greater than or equal to about 71.0 wt % to less than or equal to about 79.0 wt %, such as from greater than or equal to about 72.0 wt % to less than or equal to about 78.0 wt %, from greater than or equal to about 72.5 wt % to less than or equal to about 77.5 wt %, from greater than or equal to about 73.0 wt % to less than or equal to about 77.0 wt %, or from greater than or equal to about 74.0 wt % to less than or equal to about 76.0 wt %.

The hydrophilic granulated particulates, a compound coating, a fat source, and, optionally, one or more additional components, present in the second layer 120 may be mixed together to form the second layer 120 by any suitable method. According to embodiments, the hydrophilic granulated particulates, a compound coating, a fat source, and, optionally, one or more additional components are combined into a vessel and mixed at temperatures sufficient to allow for homogenous mixing of the hydrophilic granulated particulates, a compound coating, a fat source, and, optionally, one or more additional components. The mixing may be accomplished by conventional techniques and with conventional equipment known in the art. Once the hydrophilic granulated particulates, a compound coating, a fat source, and, optionally, one or more additional components are combined into a homogenous mixture, the mixture may be cooled to room temperature and may be formed into the second layer 120 by any suitable method and/or mechanism known in the art.

The content of hydrophilic granulated particulates, a compound coating, a fat source, and, optionally, one or more additional components in the second layer 120 may be balanced to control the water activity of the second layer 120 at varying temperatures. In addition to controlling the water activity of the second layer 120, the content of hydrophilic granulated particulates, a compound coating, a fat source, and, optionally, one or more additional components in the second layer 120 may be balanced to control the water activity of the second layer 120. By controlling the water activity, the second layer 120, a second layer may be formulated so that the second layer 120 has a suitable mouth feel.

According to embodiments, the contents of the second layer 120 may be balanced so that the second layer 120 has a water activity of greater than about 0.20, such as a water activity of greater than about 0.21, a water activity of greater than about 0.22, a water activity of greater than about 0.23, a water activity of greater than about 0.24, a water activity of greater than about 0.25, a water activity of greater than about 0.26, a water activity of greater than about 0.27, a water activity of greater than about 0.28, a water activity of greater than about 0.29, a water activity of greater than about 0.30, a water activity of greater than about 0.31, a water activity of greater than about 0.32, a water activity of greater than about 0.33, a water activity of greater than about 0.34, a water activity of greater than about 0.35, a water activity of greater than about 0.36, a water activity of greater than about 0.37, a water activity of greater than about 0.38, a water activity of greater than about 0.39, or a water activity of greater than about 0.40.

In some embodiments, the maximum water activity of the second layer 120 may be about 0.40. Accordingly, in some embodiments, the contents of the second layer 120 may be balanced so that the water activity of the second layer 120 may be from greater than or equal to about 0.20 to less than or equal to about 0.40, such as a water activity of greater than or equal to about 0.22 to less than or equal to about 0.40, a water activity of greater than or equal to about 0.24 to less than or equal to about 0.40, a water activity of greater than or equal to about 0.25 to less than or equal to about 0.40, a water activity of greater than or equal to about 0.26 to less than or equal to about 0.40, a water activity of greater than or equal to about 0.28 to less than or equal to about 0.40, a water activity of greater than or equal to about 0.30 to less than or equal to about 0.40, a water activity of greater than or equal to about 0.32 to less than or equal to about 0.40, a water activity of greater than or equal to about 0.34 to less than or equal to about 0.40, a water activity of greater than or equal to about 0.35 to less than or equal to about 0.40, a water activity of greater than or equal to about 0.36 to less than or equal to about 0.40, a water activity of greater than or equal to about 0.38 to less than or equal to about 0.40.

In some embodiments, the water activity of the second layer 120 may be from greater than or equal to about 0.21 to less than or equal to about 0.39, from greater than or equal to about 0.22 to less than or equal to about 0.38, from greater than or equal to about 0.23 to less than or equal to about 0.37, from greater than or equal to about 0.24 to less than or equal to about 0.36, from greater than or equal to about 0.25 to less than or equal to about 0.35, from greater than or equal to about 0.26 to less than or equal to about 0.34, from greater than or equal to about 0.27 to less than or equal to about 0.33, from greater than or equal to about 0.28 to less than or equal to about 0.32, or from greater than or equal to about 0.29 to less than or equal to about 0.31.

Edible Moisture Barrier Layer

As described above, embodiments of a multilayer edible product 100 comprise an edible moisture barrier layer 130 positioned between the first layer 110 and the second layer 120. One function of the edible moisture barrier layer 130 may be to prevent migration of moisture from the first layer 110 to the second layer 120. Accordingly, the edible moisture barrier layer 130 of embodiments may be formulated to prevent this migration of moisture. According to embodiments, the edible moisture barrier layer 130 comprises a high-melting fat, and, optionally, a flavoring component and/or fiber. In embodiments, the composition of the edible moisture barrier layer 130 may be different from the composition of the first layer 110 and the composition of the second layer 120.

As described above, the edible moisture barrier layer 130 comprises a high-melting fat. As described herein, the term “high-melting fat” means fats with high concentrations of saturated fatty acids and longer hydrocarbon chains. Typically, high-melting fats are typically solid at ambient temperatures and have melting points of greater than or equal to 30° C. The high-melting fats may be naturally existing or be a product of hydrogenation. Fats with trans fatty acids, such as those having a “trans” configuration, may also be included within this definition. The high-melting fat may, according to embodiments, comprise coconut oil, anhydrous milk fat, palm oil, chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof. In some embodiments, high-melting fat comprises coconut oil, anhydrous milk fat, palm oil, chocolate, or combinations thereof. The high-melting fat in the edible moisture barrier layer 130 may absorb some of the moisture originally present in the first layer 110, and mitigate the migration of moisture from the first layer 110 to the second layer 120. According to embodiments, the edible moisture barrier layer 130 comprises greater than or equal to about 80.0 wt % of the high-melting fat, such as greater than or equal to about 82.5 wt % of the high-melting fat, greater than or equal to about 85.0 wt % of the high-melting fat, greater than or equal to about 87.5 wt % of the high-melting fat, greater than or equal to about 90.0 wt % of the high-melting fat, greater than or equal to about 92.5 wt % of the high-melting fat, greater than or equal to about 95.0 wt % of the high-melting fat, greater than or equal to about 97.5 wt % of the high-melting fat, greater than or equal to about 98.0 wt % of the high-melting fat, greater than or equal to about 99.0 wt % hydrophilic powder, greater than or equal to about 99.5 wt % of the high-melting fat, greater than or equal to about 99.9 wt % of the high-melting fat, greater than or equal to about 99.99 wt % of the high-melting fat, greater than or equal to about 99.999 wt % of the high-melting fat, or greater than or equal to about 99.9999 wt % of the high-melting fat.

In some embodiments, the maximum content of the high-melting fat in the edible moisture barrier layer 130 may be about 100.0 wt %. Accordingly, in embodiments, the content of the high-melting fat in the barrier layer may be from greater than or equal to about 80.0 wt % to less than or equal to about 100.0 wt %, such as from greater than or equal to about 82.5 wt % to less than or equal to about 100.0 wt %, from greater than or equal to about 85.0 wt % to less than or equal to about 100.0 wt %, from greater than or equal to about 87.5 wt % to less than or equal to about 100.0 wt %, from greater than or equal to about 90.0 wt % to less than or equal to about 100.0 wt %, from greater than or equal to about 92.5 wt % to less than or equal to about 100.0 wt %, from greater than or equal to about 95.0 wt % to less than or equal to about 100.0 wt %, from greater than or equal to about 97.5 wt % to less than or equal to about 100.0 wt %, from greater than or equal to about 98.0 wt % to less than or equal to about 100.0 wt %, from greater than or equal to about 99.0 wt % to less than or equal to about 100.0 wt %, from greater than or equal to about 99.5 wt % to less than or equal to about 100.0 wt %, from greater than or equal to about 99.9 wt % to less than or equal to about 100.0 wt %, from greater than or equal to about 99.99 wt % to less than or equal to about 100.0 wt %, from greater than or equal to about 99.999 wt % to less than or equal to about 100.0 wt %, or from greater than or equal to about 99.9999 wt % to less than or equal to about 100.0 wt %.

In embodiments, the content of the high-melting fat in the edible moisture barrier layer 130 may be from greater than or equal to about 80.0 wt % to less than or equal to about 99.9999 wt %, such as from greater than or equal to about 82.5 wt % to less than or equal to about 99.999 wt %, from greater than or equal to about 85.0 wt % to less than or equal to about 99.99 wt %, from greater than or equal to about 87.5 wt % to less than or equal to about 99.9 wt %, from greater than or equal to about 90.0 wt % to less than or equal to about 99.5 wt %, from greater than or equal to about 92.5 wt % to less than or equal to about 99.0 wt %, from greater than or equal to about 95.0 wt % to less than or equal to about 98.5 wt %, or from greater than or equal to about 96.0 wt % to less than or equal to about 98.0 wt %.

As described above, the edible moisture barrier layer 130 may, optionally, comprise a flavoring component, such as sweeteners (e.g., sugar, stevia, allulose, monk fruit, brown sugar, maple powder, honey powder, molasses powder, powdered sugar), artificial or natural flavors (liquid or powder), colorants (e.g., FD&C colors or naturally-derived colors), or any of the previously-described preservatives. According to embodiments, the content of the flavoring component may be greater than or equal to about 0.0 wt %, such as greater than or equal to about 1.0 wt %, greater than or equal to about 2.0 wt %, greater than or equal to about 3.0 wt %, greater than or equal to about 4.0 wt %, greater than or equal to about 5.0 wt %, greater than or equal to about 6.0 wt %, greater than or equal to about 7.0 wt %, greater than or equal to about 8.0 wt %, greater than or equal to about 9.0 wt %, or greater than or equal to about 10.0 wt %. In embodiments, the maximum content of the flavoring component in the edible moisture barrier layer 130 may be about 15.0 wt %. Accordingly, in some embodiments, the content of the flavoring component in the edible moisture barrier layer 130 may be from greater than or equal to about 0.0 wt % to less than or equal to about 15.0 wt %, such as from greater than or equal to about 1.0 wt % to less than or equal to about 15.0 wt %, from greater than or equal to about 2.0 wt % to less than or equal to about 15.0 wt %, from greater than or equal to about 3.0 wt % to less than or equal to about 15.0 wt %, from greater than or equal to about 4.0 wt % to less than or equal to about 15.0 wt %, from greater than or equal to about 5.0 wt % to less than or equal to about 15.0 wt %, from greater than or equal to about 6.0 wt % to less than or equal to about 15.0 wt %, from greater than or equal to about 7.0 wt % to less than or equal to about 15.0 wt %, from greater than or equal to about 8.0 wt % to less than or equal to about 15.0 wt %, or from greater than or equal to about 10.0 wt % to less than or equal to about 15.0 wt %. In embodiments, the content of the flavoring component in the edible moisture barrier layer 130 may be from greater than or equal to about 0.0 wt % to less than or equal to about 15.0 wt %, such as greater than or equal to about 0.0 wt % to less than or equal to about 4.0 wt %, greater than or equal to about 0.0 wt % to less than or equal to about 3.5 wt %, greater than or equal to about 0.0 wt % to less than or equal to about 3.0 wt %, greater than or equal to about 0.0 wt % to less than or equal to about 3.0 wt %, greater than or equal to about 0.0 wt % to less than or equal to about 2.5 wt %, greater than or equal to about 0.0 wt % to less than or equal to about 2.0 wt %, greater than or equal to about 0.0 wt % to less than or equal to about 1.5 wt %, greater than or equal to about 0.0 wt % to less than or equal to about 1.0 wt %, or greater than or equal to about 0.0 wt % to less than or equal to about 0.5 wt %. In embodiments, the content of the flavoring component in the edible moisture barrier layer 130 may be from greater than or equal to about 0.5 wt % to less than or equal to about 15.0 wt %, such as from greater than or equal to about 1.0 wt % to less than or equal to about 12.5 wt %, from greater than or equal to about 1.5 wt % to less than or equal to about 10.0 wt %, from greater than or equal to about 2.0 wt % to less than or equal to about 7.5 wt %, from greater than or equal to about 2.5 wt % to less than or equal to about 5.0 wt %, from greater than or equal to about 2.5 wt % to less than or equal to about 4.0 wt %, from greater than or equal to about 2.5 wt % to less than or equal to about 3.0 wt %, or from greater than or equal to about 2.4 wt % to less than or equal to about 2.6 wt %. It should be understood that the above ranges are weight percentages of the flavoring component (such as, for example, the sum of sweeteners, flavors, colorants, etc.) relative the total composition of the barrier layer.

As described above, the edible moisture barrier layer 130 may, optionally, comprise fiber. The addition of fiber to the moisture barrier layer 130 provides the edible moisture barrier layer 130 with additional moisture migration prevention from the first layer 110 to the second layer 120. According to embodiments, the content of fiber may be greater than or equal to about 0.0 wt %, such as greater than or equal to about 0.5 wt %, greater than or equal to about 1.0 wt %, greater than or equal to about 1.5 wt %, greater than or equal to about 2.0 wt %, greater than or equal to about 2.5 wt %, greater than or equal to about 3.0 wt %, greater than or equal to about 3.5 wt %, greater than or equal to about 4.0 wt %, greater than or equal to about 4.5 wt %, or greater than or equal to about 5.0 wt %. In embodiments, the maximum content of fiber in the edible moisture barrier layer 130 may be about 5.0 wt %. Accordingly, in some embodiments, the content of fiber in the edible moisture barrier layer 130 may be from greater than or equal to about 0.0 wt % to less than or equal to about 5.0 wt %, such as from greater than or equal to about 0.5 wt % to less than or equal to about 5.0 wt %, from greater than or equal to about 1.0 wt % to less than or equal to about 5.0 wt %, from greater than or equal to about 1.5 wt % to less than or equal to about 5.0 wt %, from greater than or equal to about 2.0 wt % to less than or equal to about 5.0 wt %, from greater than or equal to about 2.5 wt % to less than or equal to about 5.0 wt %, from greater than or equal to about 3.0 wt % to less than or equal to about 5.0 wt %, from greater than or equal to about 3.5 wt % to less than or equal to about 5.0 wt %, from greater than or equal to about 4.0 wt % to less than or equal to about 5.0 wt %, or from greater than or equal to about 4.5 wt % to less than or equal to about 5.0 wt %. In embodiments, the content of fiber in the edible moisture barrier layer 130 may be from greater than or equal to about 0.0 wt % to less than or equal to about 4.5 wt %, such as greater than or equal to about 0.0 wt % to less than or equal to about 4.0 wt %, greater than or equal to about 0.0 wt % to less than or equal to about 3.5 wt %, greater than or equal to about 0.0 wt % to less than or equal to about 3.0 wt %, greater than or equal to about 0.0 wt % to less than or equal to about 3.0 wt %, greater than or equal to about 0.0 wt % to less than or equal to about 2.5 wt %, greater than or equal to about 0.0 wt % to less than or equal to about 2.0 wt %, greater than or equal to about 0.0 wt % to less than or equal to about 1.5 wt %, greater than or equal to about 0.0 wt % to less than or equal to about 1.0 wt %, or greater than or equal to about 0.0 wt % to less than or equal to about 0.5 wt %. In embodiments, the content of fiber in the edible moisture barrier layer 130 may be from greater than or equal to about 0.5 wt % to less than or equal to about 4.5 wt %, such as from greater than or equal to about 1.0 wt % to less than or equal to about 4.0 wt %, from greater than or equal to about 1.5 wt % to less than or equal to about 3.5 wt %, from greater than or equal to about 2.0 wt % to less than or equal to about 3.0 wt %, from greater than or equal to about 2.1 wt % to less than or equal to about 2.9 wt %, from greater than or equal to about 2.2 wt % to less than or equal to about 2.8 wt %, from greater than or equal to about 2.3 wt % to less than or equal to about 2.7 wt %, or from greater than or equal to about 2.4 wt % to less than or equal to about 2.6 wt %.

Regardless of which composition of the edible moisture barrier layer 130 may be selected, the edible moisture barrier layer 130, in embodiments, mitigates moisture migration from the wet layer to the dry layer for at least about 28 days. In some embodiments, the edible moisture barrier layer 130 mitigates moisture migration from the wet layer to the dry layer for at least about 35 days, at least about 42 days, at least about 49 days, at least about 56 days, at least about 63 days, or at least about 70 days. In one or more embodiments, the edible moisture barrier layer 130 mitigates moisture migration from the wet layer to the dry layer from greater than or equal to about 28 days to less than or equal to about 149 days, from greater than or equal to about 35 days to less than or equal to about 142 days, from greater than or equal to about 42 days to less than or equal to about 135 days, from greater than or equal to about 49 days to less than or equal to about 128 days, from greater than or equal to about 56 days to less than or equal to about 120 days, from greater than or equal to about 63 days to less than or equal to about 120 days, or from greater than or equal to about 70 days to less than or equal to about 120 days.

The high-melting fat, and, optionally, the flavoring component and/or fiber may be mixed together to form the edible moisture barrier layer 130 by any suitable method. According to embodiments, the high-melting fat, and, optionally, the flavoring component and/or fiber are combined into a vessel and mixed at temperatures sufficient to allow for homogenous mixing of the high-melting fat, and, optionally, the flavoring component and/or fiber. The heating and mixing may be accomplished by conventional techniques and with conventional equipment known in the art. Once the high-melting fat, and, optionally, the flavoring component and/or fiber are combined into a homogenous mixture, the mixture may be cooled to room temperature. Equipment that may be used for mixing, according to embodiments, includes Hobart mixers, scraped surface mixers and agitators.

Multilayer Edible Product

As described above, and with reference to FIG. 1, the multilayer edible product 100 comprises a first layer 110, a second layer 120, and an edible moisture barrier layer 130 positioned between the first layer 110 and the second layer 120. The multilayer edible product 100 may be produced by individually mixing each layer by any available means and then formed into a layered product by any suitable method or equipment capable of forming the multilayer product. According to some embodiments, the multilayer edible product 100 may be formed by co-extrusion, such as, for example, triple extrusion.

In one or more embodiments, the first layer 110 may be prepared by melting the flavoring component and the one or more gelled substances so that the flavoring component and the one or more gelled substances are easily miscible. Then, the flavoring component and the one or more gelled substances may be blended into a homogenous composition. Once a desirable composition is achieved, the thickening agent may be added while heat and shear are applied. The mixture may then be partially cooled to form the first layer 110. The second layer 120 may be prepared by melting the fat source and then slowly adding the melted fat source to a mixture of the hydrophilic granulated particulates and the compound coating. The edible moisture barrier layer 130 may be prepared by melting the high-melting fat and adding the melted high-melting fat to any other solid components that may be optionally present in the edible moisture barrier layer 130.

Once the first layer 110, the second layer 120, and the edible moisture barrier layer 130 have been prepared, the three layers may be added to a vessel in any manner as long as the first layer 110 and the second layer 120 are separated by the edible moisture barrier layer 130. In embodiments, the second layer 120 may be added to the vessel before the first layer 110 and the edible moisture barrier layer 130. A vibration may be then applied to the container so that the second layer 120 spreads evenly across a bottom of the vessel. The vessel with the second layer 120 may then be sent through a cooler or given adequate time so that the second layer 120 may solidify. Once the second layer 120 is sufficiently solidified, the edible moisture barrier layer 130 may then be applied to a top surface of the second layer 120 within the vessel. Again, the vessel with the second layer 120 and the edible moisture barrier layer 130 may then be sent through a cooler or given adequate time so that the edible moisture barrier layer 130 may solidify. Finally, the first layer 110 may be applied to a top surface of the edible moisture barrier layer 130. The vessel, which now includes the multilayer edible product 100 may then be cooled until consumption.

The embodiments described herein will be further clarified by the following examples.

### EXAMPLES

Multilayer edible products according to embodiments disclosed and described herein were produced using the following ingredients for the first layer, the second layer, and the edible moisture barrier layer.

A first layer was formed by mixing the ingredients shown in Table 1 below until a homogenous mixture was achieved.

TABLE 1

| | Weight |
|---|---|
| Ingredient | Percent |
| Mascarpone | 47.5 |
| Heavy Cream | 32.5 |
| Flavor Component | 20 |
| Total | 100 |

A second layer was formed by mixing the ingredients shown in Table 2 below until well mixed. The compound coating included a blend of coconut oil, confectioner's sugar, whey, soy lecithin, and salt. The compound coating was comprised of 73% solids, had a water activity of about 0.30, and had a fat content of 59%. To prepare the second layer, the anhydrous milk fat and the compound coating were melted. Then, the melted anhydrous milk fat and compound coating were combined with the cookie crumbs until a homogenous mixture was achieved.

TABLE 2

| | Weight |
|---|---|
| Ingredient | Percent |
| Cookie Crumbs | 61.4 |
| Compound Coating | 19.3 |
| Anhydrous Milk Fat | 19.3 |
| Total | 100 |

An edible moisture barrier layer was formed with the ingredients shown below in Table 3. To form the composition, the high-melting fat was melted and then mixed with the flavor component and the fiber until a homogenous mixture was achieved.

TABLE 3

| | Weight |
|---|---|
| Ingredient | Percent |
| High-Melting Fat | 95.0 |
| Flavor Component | 2.5 |
| Fiber | 2.5 |
| Total | 100.0 |

A multilayer edible product was then formed by taking the warm second layer and pressing a thin layer about 0.25 inches thick into a 4 ounce soufflé cup. Then, the warm second layer was allowed to cool into a solid second layer. Next, the melted edible moisture barrier layer was applied to the cool second layer at a thickness of about 0.10 inches. Once the edible moisture barrier layer was cooled and became solidified, the first layer was applied on top of the edible moisture barrier layer. The first layer was densely applied at a thickness of about 1.50 inches such that the edible moisture barrier was completely covered by the first layer, thus forming the multilayer edible product.

From the multilayer edible product formed according to this method, it was found that the edible moisture barrier layer prevented moisture migration from the first layer to the second layer for 70 days. While the edible moisture barrier layer is functional without added fiber, fiber was found to extend the prevention of moisture migration past 70 days. It was also found that such an elevated amount of high-melting fat in the edible moisture barrier layer was critical to edible moisture barrier layer functionality.

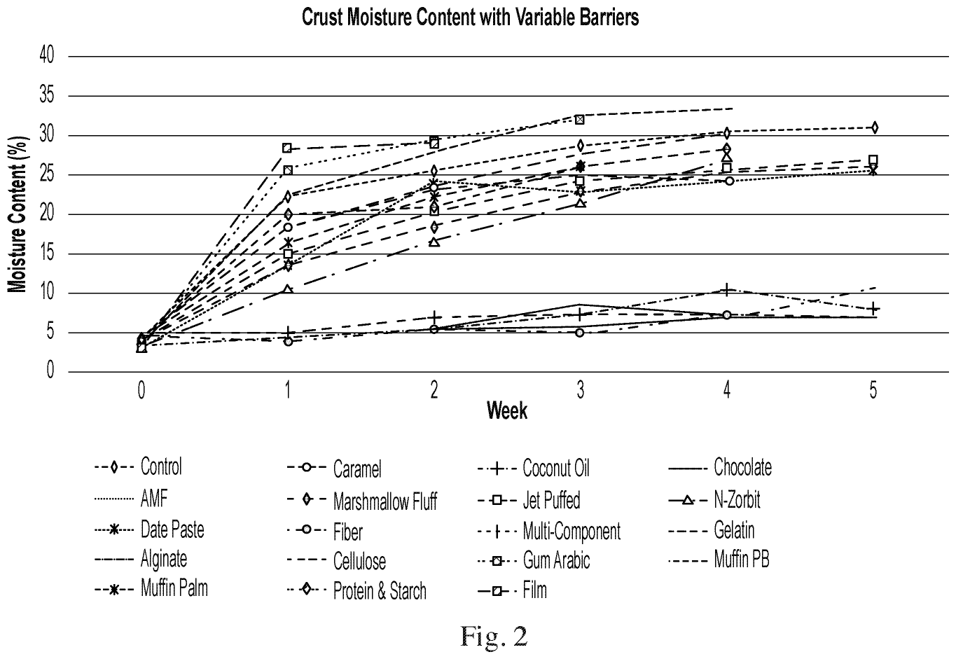

The moisture migration between the first layer and the second layer using various edible moisture barriers is further shown in FIG. 2. For the multilayer edible products shown in FIG. 2, each of the second layers (e.g., the crust) was produced in a uniform manner. First, graham crackers were crushed to a homogenous consistency and placed into a vessel. In a separate vessel, anhydrous milk fat was completely melted. The melted anhydrous milk fat was then evenly combined with the crushed graham crackers to form a crust having 80 wt % of the crushed graham crackers and 20 wt % of the anhydrous milk fat. Then, 12.0±0.1 g of the crust was placed into a 4 ounce vessel and evenly pressed onto a bottom surface of the vessel. A lid was then placed on the 4 ounce vessel packed with crust and refrigerated. Then, the various edible moisture barriers were placed on top of crust and refrigerated. Finally, a first layer (e.g., a high-moisture layer) was placed on top of the edible moisture barrier. This process was repeated until each of the various multilayer edible products were produced.

As shown in FIG. 2, edible moisture barriers that include high-melting fats prevent the second layer from having a moisture content that exceeds 15%, even after five weeks. These high-melting fats include anhydrous milk fat, coconut oil, chocolate, a multi-component layer (a mixture of 61.5 wt % sugar, 0.5 wt % oat fiber, and 38.0 wt % anhydrous milk fat), and a fiber layer (a mixture of 95.4 wt % AMF and 4.6 wt % fiber). In contrast, barriers that are substantially free of high-melting fats do not sufficiently prevent moisture migration between the first layer and the second layer. Sufficient moisture migration may be defined a moisture content in the second layer of less 10% after three weeks and less than 15% after four weeks. Therefore, the edible moisture barriers, according to the embodiments described herein, mitigate moisture migration from the first layer to the second layer when compared to typical barriers

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multilayer edible product comprising:
a first layer having a water activity greater than 0.75;
a second layer having a water activity from 0.20 to 0.40; and
an edible moisture barrier layer positioned between the first layer and the second layer, wherein
the edible moisture barrier layer comprises high-melting fat and mitigates moisture migration from the first layer to the second layer.

2. The multilayer edible product of claim 1, wherein the first layer comprises one or more gelled substances, a flavoring component, and a thickening agent.

3. The multilayer edible product of claim 2, wherein the one or more gelled substances comprise mascarpone, cream cheese, heavy cream, soft cheese, skim milk, 1% milk, 2% milk, whole milk, whipping cream, heavy cream, custards, fruit curds, savory pies (meat and/or vegetable), sweet pies (fruit and/or vegetable based), or combinations thereof.

4. The multilayer edible product of claim 16, wherein the flavoring component comprises chocolate, white chocolate, cocoa, jelly, jam, curd, peanuts, tree nuts, coconut paste, butter, caramel, curd, salt, sugar, brown sugar, fruit powders, fruit purees, or combinations thereof.

5. The multilayer edible product of claim 16, wherein the first layer comprises from 25 wt % to 90 wt % of the one or more gelled substances, from 0.5 wt % to 30 wt % of the flavoring component, and from 0.1 wt % to 10 wt % of a thickening agent.

6. The multilayer edible product of claim 1, wherein the second layer comprises from 70 wt % to 80 wt % of solid particulates.

7. The multilayer edible product of claim 1, wherein the second layer comprises hydrophilic granulated particulates, a compound coating, and a fat source.

8. The multilayer edible product of claim 7, wherein the second layer comprises from 50 wt % to 70 wt % of the hydrophilic granulated particulates, from 10 wt % to 30 wt % of the compound coating, and from 10 wt % to 30 wt % of the fat source.

9. The multilayer edible product of claim 7, wherein the fat source comprises palm kernel oil, coconut oil, cocoa butter, palm oil, anhydrous milk fat, non-anhydrous milk fat, butter, propylene glycol, glycerin, glycerol, or combinations thereof.

10. The multilayer edible product of claim 7, wherein the hydrophilic granulated particulates comprise breadcrumbs, cake crumbs, cookie crumbs, crackers, or combinations thereof.

11. The multilayer edible product of claim 7, wherein the compound coating comprises edible oil and hydrophilic powder.

12. The multilayer edible product of claim 11, wherein the compound coating further comprises whey, lecithin, salt, or combinations thereof.

13. The multilayer edible product of claim 11, wherein the edible oil comprises coconut oil, palm kernel oil, cocoa butter, palm oil, hydrogenated cottonseed oil, or combinations thereof.

14. The multilayer edible product of claim 11, wherein the hydrophilic powder comprises brown sugar, granulated sugar, invert sugar, milled sugar, or combinations thereof.

15. The multilayer edible product of claim 11, wherein the compound coating comprises from 50 wt % to 70 wt % of the edible oil and from 20 wt % to 30 wt % of the hydrophilic powder.

16. The multilayer edible product of claim 15, wherein the compound coating further comprises from 5 wt % to 15 wt % of one or more additional components selected from the group: a flavoring agent, a stabilizer, a bulking agent, a preservative, or combinations thereof.

17. The multilayer edible product of claim 1, wherein the high-melting fat comprises coconut oil, anhydrous milk fat, palm oil, chocolate, or combinations thereof.

18. The multilayer edible product of claim 1, wherein the edible moisture barrier layer comprises greater than or equal to 90 wt % of the high-melting fat.

19. The multilayer edible product of claim 1, wherein the edible moisture barrier mitigates moisture migration from the wet layer to the dry layer for at least 70 days.

20. A multilayer edible product comprising:
a first layer comprising one or more gelled substances, a flavoring component, and thickening agent;
a second layer comprising hydrophilic granulated particulates, a compound coating, and a fat source; and
an edible moisture barrier layer positioned between the first layer and the second layer, wherein
the edible moisture barrier layer comprises high-melting fat and is configured to prevent moisture migration from the first layer to the second layer.
